(19) United States
(12) Patent Application Publication
(10) Pub. No.: US 2011/0146845 A1
(43) Pub. Date: Jun. 23, 2011

(54) FLUX AND METHOD FOR THE REDUCTION OF OXIDE LAYERS ON METALLIC SURFACES

(75) Inventor: Manfred Laudenklos, Schoeneck (DE)

(73) Assignees: KS ALUMINIUM-TECHNOLOGIE GMBH, Neckarsulm (DE); KS KOLBENSCHMIDT GMBH, Neckarsulm (DE); GELITA AG, Eberbach (DE)

(21) Appl. No.: 12/374,637

(22) PCT Filed: May 25, 2007
(86) PCT No.: PCT/EP07/04655

§ 371 Date: Jan. 21, 2009

(30) Foreign Application Priority Data
Jul. 28, 2006 (DE) 10 2006 035 748.5

(51) Int. Cl. B23K 35/362; B22D 19/00; B22D 27/00; B23K 1/20

(52) U.S. Cl. 148/26; 148/23; 164/75; 164/56.1; 228/223

(57) ABSTRACT

A flux for application on and for reduction of oxide layers on a metal surface. The flux includes potassium fluoride, sodium fluoride, remaining moieties of water and gelatin. The can also include a reactant comprising moieties of at least one of the compositions of zirconium fluoride, lithium fluoride, sodium fluoride, potassium cryolite and potassium aluminum fluoride (KaAlF₄), moieties of salts on the basis of at least one of the elements zirconium, lithium, potassium, sodium, bismuth boron and titanium and gelatin. The flux can be used in a method to reduce oxide layers on a metal surface by applying the flux onto the metal surface.

The invention refers to a flux for application on and reduction of oxide layers on a metallic surface that is composed at least of potassium fluoride, sodium fluoride and moieties of water. The invention further refers to a method for casting metal components of at least two different materials, of which one material is an iron-based alloy and the other is an aluminum-based alloy, the method comprising the following steps:
applying a metallic layer on a body of an iron-based alloy, the metallic layer being an aluminum-based alloy, and the application being effected by immersion into an aluminum melt,
placing the coated body into a casting mold,
casting-in the coated body with an aluminum-based alloy, the invention referring to a method, wherein a liquid alloy of light metal is scooped from an open die-cast and filled into the casting mold. Another part of the invention is directed to a method for materially connecting metal components, and, finally, the invention refers to a method for reducing oxide layers on solid or liquid metallic surfaces.

By far the majority of metal materials form oxide layers under the effects of atmosphere and in particular of oxygen. These oxide layers are in some cases desirable, such as with aluminum sheets, for example, but in other instances the oxide layers show disadvantageous effects on the production process. When liquid aluminum alloys are used, as is the case in low-pressure casting of aluminum pistons, an oxide skin forms immediately at the surface of the liquid aluminum alloy in the die-cast, which has an adverse effect on the casting quality of the casting products.

The past has seen various manual, as well as automated methods for removing the oxide layer on molten aluminum alloys.

Thus, for example, it is common practice and described in DE 34 11 970, to manually scoop the aluminum from the crucible containing the liquid aluminum alloy, using a ladle, and to fill it into the casting mold to produce a piston for an internal combustion engine, for example. When a worker scoops the liquid aluminum from the crucible, he will at the same time also scoop up the oxide skin that has formed on the liquid aluminum. This is avoided by the worker manually scooping off and thus removing the oxide skin, also referred to as dross, with a ladle. In particular with aluminum and aluminum alloys, it is a fact that a new oxide skin is formed immediately, so that it is virtually impossible to fully eliminate the skin.

For an automation of this manual operation, DE 34 11 970 further describes an automated removal of the dross. A method is described, wherein an immersed ladle cooperates with a stripper also immersed in the molten metal in the die-cast, said stripper being displaceable towards the ladle by an actuator to push the dross onto the ladle, and wherein, under the action of further drive means, the ladle is further swung in a vertical plane around an axis of rotation to fling out the dross from the die-cast. Thereby, a minimization of the aluminum oxide introduced into the casting member is achieved.

In the interest of a reduction of, in particular, the disadvantages of the oxide layers on workpieces to be cast in, a method is known from DE 101 13 962 A1 that uses a flux to deoxidize oxide layers existing on the workpieces. Before the workpiece to be cast in is provided with another metal layer, a flux is applied on the metal workpiece, whereby, on the one hand, the oxides on the workpiece are reduced and, on the other hand, the metallurgic bond of the cast-in material with the material to be cast in is enhanced, since the oxide layer is broken up and thus the diffusion-retardant layer is eliminated. One problem arising from such metallurgic bonds is the oxide layer forming between the metallic layer on the member to be cast in. The oxide layers of aluminum have a very high melting point of about 2000° C., whereas typical aluminum alloys have a melting point that is most often far below 1000° C., in particular below 800° C. The cast-in material is thus unable to break up the oxide layer, resulting in an increase of bonding defects. To reduce or dissolve these high-melting oxide layers, fluxes are applied onto the body prior to casting-in.

A method for manufacturing a cast composite part from an aluminum alloy and a wear-resistant material forming an inner layer is described in DE 2 344 899. The method is characterized in that, immediately before casting-in, the core to be coated is immersed in an aluminum melt to form a diffusion layer of the aluminum and the wear-resistant material. This method has become known as the so-called Alfin method. For the bonding of aluminum melt, the document also describes the use of fluxes. As described, it is suitable for a better release of the core after the casting to coat the core with a release agent prior to covering the core with the wear-resistant material.

It is an object of the invention to provide an agent with a chemical composition having a great potential difference, which agent allows for the reduction of oxide layers in a manner heretofore unknown, and which further substantially improves a metallurgic bonding between a cast workpiece and a cast-in material. Moreover, it is an object of the invention to provide a method, wherein the removal of oxide layers in crucibles can be omitted. Further, it is another object of the invention to provide a method with which the oxide skin on liquid or solid metal surfaces is reduced or completely removed.

The object of the invention is achieved by providing a flux formed by moieties of zirconium fluoride and/or lithium fluoride and a reactant of moieties of salts on the basis of zirconium and/or lithium and/or potassium and/or sodium and/or bismuth and/or boron and water. With respect to the methods to be improved, the object of the invention is achieved, for conventional methods, by applying the improved flux immediately on the workpieces and/or by applying the flux immediately onto the surface of the aluminum melt. Due to the composition of the flux according to the invention, it is now possible to entirely or almost entirely remove the oxide layer forming and to provide a long-term protection against the forming of new oxide layers. With respect to the casting methods and the use of the flux on the surface of the liquid casting metal, it is now possible to completely eliminate the mechanical removal of the oxide layer. In particular, the mechanical stripping of the dross from the liquid metal surface and the discharge of the stripped dross from the die-cast into a waste container by the caster can be omitted.

With respect to the agent, a flux is provided which additionally contains gelatine. In an advantageous development of the invention, the flux additionally contains moieties of zirconium fluoride and/or lithium fluoride, sodium silicon fluoride and/or potassium cryolite and/or potassium aluminum fluoride (KaAlF₄) and moieties of salts on the basis of zirconium and/or lithium, and/or potassium and/or sodium and/or bismuth and/or boron and/or titanium and water. The mixture, present in a liquid or granular form, of a flux, especially a flux on the basis of fluorine, a reactant, such as zirconium and bismuth or lithium and bismuth or zirconium, titanium and bismuth, as well as gelatine is used especially for the reduction of aluminum oxides such as Al₂O₃. As the fluorine-based flux, a flux known by the trade name of “NOCOLOK” can be used, which flux NOCOLOK is manufactured and sold by Solvay. A particular advantage is obtained if gelatine is added to the flux. In this context, reference is made in particular to the gelatine sold under the trade name “Gelita” by Gelatinegruppe. The use of this gelatine in combination with the flux and the reactant allows in particular, but not restricted thereto, to reduce oxide layers on light metal alloys, preferably aluminum. The reactant in the flux is formed by moieties of zirconium fluoride and/or lithium fluoride and moieties of salts on the basis of zirconium and/or lithium and/or potassium and/or sodium and/or bismuth and/or boron and/or titanium and water. Here, the percentage of zirconium is between 5 percent by weight and 20 percent by weight, the percentage of lithium is between 8 percent by weight and 25 percent by weight and the percentage of potassium is between 2 percent by weight and 10 percent by weight and the percentage of sodium is between 1 percent by weight and 8 percent by weight and the percentage of bismuth is between 0.5 percent by weight and 5 percent by weight and the percentage of boron is between 2 percent by weight and 10 percent by weight. The gelatine added to the flux is principally made from calcium and/or magnesium and organic and inorganic components making a defined contribution to the potential equalization during dispersion and to the acceleration of the reaction. The percentage of gelatine is between 0.5 percent by weight and 5 percent by weight in the flux. The major components of the gelatine are calcium at a proportion of 3950 mg per kg and magnesium at a proportion of 1500 mg per kg.

Moreover, the invention refers to the use of the flux in a casting method, wherein parts of different materials are formed. It is a problem with such methods that the different materials have different specific properties which have adverse effects on the casting method. If, for example, a member made from an iron-based alloy is embedded in a light metal alloy, such as aluminum, for example, regions are formed between the different materials during the casting-in, which regions, due to the different melting temperatures, are not metallurgically bonded, but the member is rather enclosed by the light metal alloy, where it is merely held in position mechanically. One method for an improved metallurgic bonding of the iron-based member to the surrounding aluminum melt is the known Alfin method. For a better bonding of the casting-in material to the member, the member is immersed into an aluminum melt and placed into the casting mold immediately thereafter.

The invention will be explained in detail hereinafter in the context of the use of the flux in a casting method, making reference to an embodiment thereof. In the sole FIGURE:

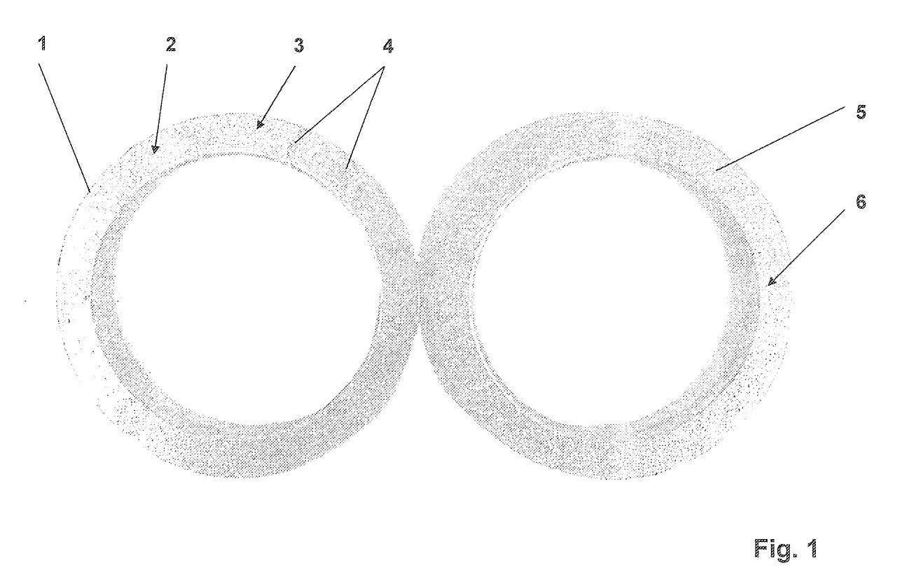

FIG. 1 illustrates two ring carriers for a piston, coated with a layer of aluminum.

A ring carrier coated in an Alfin method and forming a part of a piston is illustrated in FIG. 1. On the left, FIG. 1 shows a ring carrier 1 formed from an iron-based alloy and which has been coated with an aluminum layer 2 according to the Alfin method. In addition to a mechanical clamping in the casting-in material, the ring carrier has circumferential grooves 3 which further fix the ring carrier 1 in the casting-in material.

The ring carrier 1 illustrated in FIG. 1 has been immersed into an aluminum melt whose surface has been provided with a conventional flux, in the present case NO—COLOC. This test aimed at reducing the oxides on the surface of the aluminum melt so that the ring carrier could be coated all around the circumference and all over its surface. The application of the agent by the name of NOCOLOC and of the gelatine significantly reduced the dross forming on the aluminum melt, so that a reduced adhesion of the aluminum layer 2 to the ring carrier 1 occurred only in a few regions 4. The application of the flux according to the invention on the aluminum melt drastically reduces the oxide layer forming on the liquid melt, so that a result can be obtained that is clearly superior to prior art with respect to the Alfin layer 2 on the ring carrier 1.

The ring carrier 5 on the right side in FIG. 1 has been alfin-treated in a melt to which a flux had been added that was formed from the conventional flux NOCOLOC, a reactant and gelatine. By applying the flux of the present invention as defined in claim 4, the oxide layer on the aluminum melt could be reduced almost entirely and for a long time, so that the ring carrier 5 could be immersed into the aluminum melt of the melting bath due to the flux on the surface of the aluminum melt without oxides being deposited on the surface

of the ring carrier 5. The alfin-treated surface 6 of the ring carrier 5 shows a continuously uniform Alfin layer, or an aluminum coating, free of defects. Thus, the invention provides a casting method for manufacturing metal parts from at least two different materials, wherein an optimum bonding of a metal layer 2, 6 can be deposited on a member 1, 5.

For the reduction of oxides present on the member 1, 5, the invention proposes to apply a flux according to one of claims 1 to 4 onto the member 1, 5 provided with the metal layer 2, 6, before placing the member in the casting mold. Thus, the oxides forming on the metal layer 2, 6 can also be reduced, so that a metallurgic bond between the metal layer 2, 6 and the casting-in material is obtained. Typically, the casting-in materials of choice are aluminum alloys and preferably aluminum silicon alloys. It is obvious that this merely is an embodiment and that the casting method is naturally also applicable to other parts, such as cylinder liners or crankshaft bearings in cylinder crank housings, for example. The method of the present invention is especially applicable where a metallurgic bond between different materials is to be obtained.

The flux according to one of claims 1 to 4, either in a liquid or granular state, is applied immediately on the aluminum melt, e.g. AlSi9, AlSi12, Al 99,5, in an order of 10 to 100 g per square centimetre. By applying the flux on the aluminum melt, the oxide layer is reduced instantly and a lasting oxide-free surface is formed on the free surface of the die-cast of the molten aluminum alloy material.

Another field of application of the flux according to the invention is the use in a method for manufacturing a cast member, wherein a liquid light metal alloy is scooped from an open die-cast and filled into a casting mold. The methods known from prior art show solutions that provide for a manual or automated removal of oxide layers or dross on the liquid surfaces of the aluminum alloys. It is a drawback of such methods that, on the one hand, the aluminum oxide layers can never be removed completely, and that, on the other hand, the aluminum oxide layers form again instantaneously, i.e. within fractions of a second.

The use of the flux of the invention in a method for manufacturing a cast member, wherein a flux according to one of claims 1 to 4 is applied onto the surface of the light metal alloy prior to the scooping of the light metal alloy, allows to completely drop the removal of the oxide layer. The flux reduces or dissolves the oxide layer on the light metal alloy, so that the scooping ladle can dive into an oxide-free surface and can also scoop oxide-free aluminum or an aluminum alloy. This allows for a casting of cast members that is free of oxide layers or wherein the oxide layers are at least reduced to a very large extent.

The flux is applied immediately on the open surface of the molten metal in the die-cast in an amount of 10 to 100 g, preferably 20 g, per square centimetre, the surface having a diameter of about 40 cm. This reduces the oxides on the surface of the molten liquid metal completely, so that the liquid aluminum alloy metal is available for processing without any oxide layers.

Besides application in casting methods, the present flux is applicable to methods for materially bonding metal parts. In material bonding, such as welding, oxides on the surfaces of the materials are disadvantageous, since the oxides may get into the weld pool or the joint surface, thereby causing defects in the weld seam. The use of a flux α-cording to one of claims 1 to 4 reduces the oxide layers, both on iron-based alloys and on aluminum-based alloys, such that the joint surfaces are permanently deoxidized.

Moreover, the flux is applicable for a reduction of oxide layers on metal, ferrous or aluminous surfaces formed from an aluminum base. The flux of the present invention is thus not only applicable on molten aluminum alloys, but also on solid metal surfaces that form oxide layers on their surfaces.

1-12. (canceled)

13. A flux for application on and for reduction of oxide layers on a metal surface, the flux comprising potassium fluoride, sodium fluoride, remaining moieties of water and gelatin.

14. The flux as recited in claim 13, wherein the gelatin is composed of at least one of calcium, magnesium, organic and inorganic components and is present in an amount of from 0.5 to 5 wt.-%.

15. The flux as recited in claim 13, wherein the flux is composed of at least one of 5 to 20 wt.-% zirconium, 0.1 to 5 wt.-% titanium, 8 to 25 wt.-% lithium, 2 to 10 wt.-% potassium, 1 to 8 wt.-% sodium, 0.5 to 5 wt.-% bismuth and 2 to 10 wt.-% boron.

16. A flux for application on and for reduction of oxide layers on a metal surface, the flux comprising:
a reactant comprising moieties of at least one of the compositions of zirconium fluoride, lithium fluoride, sodium fluoride, potassium cryolite and potassium aluminum fluoride (KaAlF₄);
moieties of salts on the basis of at least one of the elements zirconium, lithium, potassium, sodium, bismuth boron and titanium; and
gelatin.

17. The flux as recited in claim 14, wherein the gelatin is composed of at least one of calcium, magnesium, organic and inorganic components and is present in an amount of from 0.5 to 5 wt.-%.

18. The flux as recited in claim 14, wherein the flux is composed of at least one of 5 to 20 wt.-% zirconium, 0.1 to 5 wt.-% titanium, 8 to 25 wt.-% lithium, 2 to 10 wt.-% potassium, 1 to 8 wt.-% sodium, 0.5 to 5 wt.-% bismuth and 2 to 10 wt.-% boron.

19. A method for casting metal parts from at least two different materials, one of said materials being an iron-based alloy and the other being an aluminum-based alloy, the method comprising:
applying an aluminum-based alloy layer on a member of an iron-based alloy by immersion in an aluminum melt to obtain a coated member;
placing the coated member in a casting mold; and
casting-in the coated member with an aluminum-based alloy;
applying before the member of an iron-based alloy is immersed into the aluminum melt, a flux comprising potassium fluoride, sodium fluoride, remaining moieties of water and gelatin onto the surface of the aluminum melt to reduce or dissolve an oxide skin formed on the aluminum melt so that the aluminum-based alloy layer establishes a metallurgic bond with the member of an iron based alloy when immersed into the aluminum melt.

20. The method as recited in claim 19, wherein the flux is applied onto the aluminum melt in a liquid or granular state.

21. The method as recited in claim 19, further comprising applying a flux as recited in claim 1 onto the coated member before placing the coated member in the casting mold.

22. A method for manufacturing a cast member, the method comprising:
scooping a liquid light-metal alloy from an open die-cast; and
filling the liquid light-metal alloy into a casting mold;
applying before the scooping of the liquid light-metal alloy, a flux comprising potassium fluoride, sodium fluoride, remaining moieties of water and gelatin onto the surface of the liquid light-metal alloy to reduce or dissolve an oxide layer formed on the liquid light-metal alloy.

23. The method as recited in claim 22, further comprising applying the flux onto the open die-cast in an amount of about 10 to 100 g per 0.3 m².

24. A method for materially bonding metal parts, the method comprising:
applying a flux comprising potassium fluoride, sodium fluoride, remaining moieties of water and gelatin onto those portions of the metal parts to be bonded to reduce or dissolve an oxide layer forming thereon; and
bonding the metal parts.

25. The method recited in claim 24, wherein the bonding is undertaken by welding.

26. A method for reducing oxide layers on a metal surface, the method comprising applying a flux comprising potassium fluoride, sodium fluoride, remaining moieties of water and gelatin onto a metal surface.

27. The method recited in claim 26, wherein the metal surface is formed from at least one of an aluminum-based alloy and an iron-based alloy.
